(19) United States
(12) Patent Application Publication
(10) Pub. No.: US 2014/0267150 A1
(43) Pub. Date: Sep. 18, 2014

(54) APPARATUS AND METHOD FOR DETECTING POSITION

(71) Applicant: LG ELECTRONICS INC., Seoul (KR)

(72) Inventor: Hashimoto MASASHI, Seoul (KR)

(73) Assignee: LG ELECTRONICS INC., Seoul (KR)

(21) Appl. No.: 14/095,802

(22) Filed: Dec. 3, 2013

(30) Foreign Application Priority Data
Mar. 14, 2013 (KR) 10-2013-0027309
May 21, 2013 (KR) 10-2013-0057183

(51) Int. Cl. G06F 3/046

(52) U.S. Cl. CPC G06F 3/046
USPC 345/174

(57) ABSTRACT

A position detection apparatus and method are provided. The apparatus includes a touchscreen on which an image is displayed, a sensor, and a controller. The sensor includes at least one hall element. The method includes detecting a touch coordinate input into a touch panel through the touchscreen, storing the detected touch coordinate, counting a number of detected touch positions to determine whether a an executing application program permits only a single touch input, and selectively operating the sensor to detect a position of a magnet according to whether the an executing application program permits only the single touch input.

### CROSS-REFERENCE TO RELATED APPLICATIONS

This application claims the benefit under 35 U.S.C. §119 of Korean Patent Applications No. 10-2013-0027309, filed Mar. 14, 2013, and No. 10-2013-0057183, filed May 21, 2013, which are hereby incorporated by reference in their entirety.

### BACKGROUND OF THE INVENTION

1. Field of the Invention

The present disclosure relates to an apparatus and method for detecting a position.

2. Discussion of the Related Art

Touch panel devices are devices for detecting a position when a user touches a touch screen using their hand or a stylus pen. Touch panels are being used for personal digital assistants (PDAs), automated teller machines (ATMs), and display devices. Due to these touch panel technologies, a user's finger or pen may serve as an input unit of a computer.

A position detection method which is adopted for such a touch panel may include a resistive overlay method for detecting a position through a pressure change when a finger or pen contacts a touch screen and a capacitive overlay method (hereinafter, referred to as an “electrostatic method”) for detecting a position through a capacitance change between sensor conductors.

In a system for detecting a contact position of a stylus pen through the electrostatic method, if a user's finger or palm contacts a surface of a touch panel while a pen contacts the surface of the touch panel, it may be difficult to determine the touch position intended by the user from the touched positions.

### SUMMARY OF THE INVENTION

Embodiments provide a position detection apparatus and method which is capable of accurately detecting a position of a stylus pen even though a multi touch input in which a user's finger and the stylus pen are touched at the same time occurs.

Particularly, because it is unnecessary to provide a power supply unit or a capacitor in a stylus pen, a touch position may be detected by using a magnet without including devices such as a coil and the like in the stylus. That is, because it is unnecessary to supply a power to the stylus pen, it may be unnecessary to supply a power to a touch panel by using a coil or provide a power supply part within the stylus pen.

Embodiments also provide a position detection apparatus in which a hall element is provided in a touch panel to accurately detect a position of a stylus pen, and the number of used hall elements is significantly reduced, and a position detection method.

In one embodiment, a position detection apparatus including a display panel on which an image is displayed includes: an electrostatic type position detector for recognizing touch of a finger or pen; a magnetostatic field position detector for detecting a position of a magnet disposed within the pen; and a controller determining a touch position of the finger or pen by using position detection information transmitted from the electrostatic type position detector and the magnetostatic field position detector, in which the magnetostatic field position detector includes a magnetostatic field sensor part including at least one hall element, and the controller selectively operates the magnetostatic field position detector according to whether an application program running through the display panel permits a single touch input or multi touch input as a user's input.

In another embodiment, a position detection method includes: detecting a touch coordinate input into a touch panel through an electrostatic method; storing the touch coordinate detected by the electrostatic method; counting the number of detected touch position to determine whether an executing application program permits only a single touch input; and selectively operating a magnetostatic field position detector for detecting a position of a magnet by using a magnetic field generated from the magnet according to whether an executing application program permits only the single touch input.

The details of one or more embodiments are set forth in the accompanying drawings and the description below. Other features will be apparent from the description and drawings, and from the claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a perspective view of a position detection apparatus according to an embodiment.

FIG. 2 is a view of a case in which a user uses a pen.

FIGS. 3 and 4 are views illustrating configurations of the position detection apparatus according to an embodiment.

FIG. 5 is a schematic view of a hall element used in the position detection apparatus according to an embodiment.

FIG. 6 is a view illustrating a magnetostatic field signal processor of the position detection apparatus according to an embodiment.

FIG. 7 is a flowchart illustrating a position detection method according to a first embodiment.

FIG. 8 is a flowchart illustrating a position detection method according to a second embodiment.

FIGS. 9 to 11 are views illustrating an arrangement of hall elements constituting a magnetostatic field position detector.

FIGS. 12 to 14 are views of a pen which is capable of being used in the position detection apparatus according to the first embodiment.

FIG. 15 is a view illustrating an inner structure of a pen according to a second embodiment.

FIG. 16 is a view illustrating an inner structure of a pen according to a third embodiment.

FIGS. 17 to 20 are views of a pen according to a fourth embodiment.

### DETAILED DESCRIPTION OF THE EMBODIMENTS

Reference will now be made in detail to the embodiments of the present disclosure, examples of which are illustrated in the accompanying drawings.

FIG. 1 is a perspective view of a position detection apparatus according to an embodiment. A position detection apparatus according an embodiment includes a stylus pen (hereinafter, referred to as a “pen”) as a first input unit and a detection area 30 for detecting a position touched or input by a finger 10 as a second input unit. A protection cover formed of glass or acrylic that will be described later is disposed on the detection area 30. Also, a display panel such as a liquid crystal display (LCD) or an organic light emitting display (OLED) is disposed under the detection area 30. A signal transmitted from a control unit such as computer is displayed on the touch panel.

Drawing of pictures, writing of characters, and selection of a displayed image according to manipulation of the pen 20 may be realized by manipulating the pen 20 on the detection area 30. Here, the above-described functions may be performed by an input through touch of the finger 10. When the detection area 30 is touched or input by using at least two fingers of the user, this may be referred to as a multi touch input. Here, a command for expanding/reducing or rotating a screen may be performed according to an executing application program (software) or mobile application (hereinafter, referred to an application program).

In addition, when the detection area 30 is touched or input by using a finger 10 of the user and the pen 20, this also may be referred to as a multi touch input. Here, various manipulations may be enabled according to an executing application program. In the current embodiment, if an executing application program recognizes only a single touch input, only a position of the pen 20 may be recognized in disregard of the touch of the user's finger or palm.

The stylus pen has been widely known as a unit for the touch input. To distinguish the input using the pen from the touch through the user's finger or palm, a circuit such as a coil and capacitor may be provided. Here, the circuit can detect a magnetic or electric field between the pen and the touch panel to detect a position of the pen. However, in this instance, a circuit for generating an electric or magnetic field may be provided in the pen. Also, a power supply for supplying a power to the circuit may be provided in the pen. Further, when the coil for wirelessly supplying a power to the pen is used in the touch panel, a complex circuit may be provided within the pen or the touch panel.

However, in the pen 20 according to the current embodiment, only a magnet is provided to recognize a position through a hall element that will be described later. Also, when the pen 20 contacts the touch panel, at least one portion of the pen may be formed of a conductive material to detect a position of the pen through an electrostatic method. Unlike the related art, the circuit including the coil or capacitor for generating the electric or magnetic field and the power supply for supplying the power to the circuit is not included.

To more precisely detect the position of the pen, an alternating magnetic field is generated to improve accuracy of position detection, and then the position can be detected through the electrostatic method. However, because the pen generates the alternating magnetic filed, a structure for supplying a power to the pen may be required, and thus, noise may be increasingly generated in the circuit such as the touch panel.

The pen according to the current embodiment will be described below in detail with reference to the accompanying drawings. In particular, FIG. 2 is a view illustrating a user using a pen. FIG. 2 illustrates the user using the pen in a smart phone or a tablet PC. If the user intends that the palm does not intentionally contact the detection area when the user touches the detection area by using the pen, the apparatus may be sufficient if only the touch with respect to the pen is recognized according to conditions. However, in actual use, the apparatus has to recognize only the touch of the pen even though the palm contacts the detection area. Thus, the position detection apparatus may approach the user's intension when the apparatus recognizes only the touch of the pen without recognizing the touch of the palm in either case.

One embodiment of the present invention provides an apparatus which can detect positions of the finger, the palm, and the pen through the electrostatic method, and also accurately distinguish a position of the pen from the touch positions detected by the electrostatic method. To distinguish the position of the pen from the detected touch positions, it should take notes of a user's actual feature which uses the pen when the user's palm contacts the detection area. In general, the pen to be used as the input unit by the user and the user's palm may be spaced a predetermined distance from each other. Here, the spaced distance may be about 3 cm.

The distance between the palm and the pen, which may be different according to users may have relevance to a distance between hall sensors for detecting a position of the magnet within the pen through a magnetostatic field method in the present embodiment. In a display device having a size of about 4 inches to about 6 inches such as the smart phone, if it is intended as the distance between the palm and the pen is generally about 3 cm, about 5 to 6 hall sensors may be provided.

Also, in the present embodiment, when a position of the pen (magnet) is detected by the hall sensors, analog output voltages of the plurality of hall sensors are not converted into digital values by using an AD converter. Also, as an arithmetic circuit and memory as well as the AD converter are not needed so as to detect the position of the pen through the magnetostatic field method.

That is, in the present embodiment, information that can clearly determine that the pen does not contact the detection area may be removed first from information in which the position of the pen calculated through the electrostatic method and the position of the finger (palm) are mixed. Then, an output voltage of a hall element nearest to each position among the remaining touch positions may be determined to compare a large and small relationship between the output voltages of the hall sensors, thereby determining a position of the pen through the comparison result.

If it is determined that the pen does not contact the detection area, the output voltage of the hall element may be maintained to a value (e.g., about 0 V) less than a threshold value. On the other hand, if it is determined that the pen contacts the detection area, the output voltage of the hall element may be greater than the threshold value (e.g., about 0 V). Through the above-described method, the AC converter and the arithmetic circuit are not needed. On the other hand, when the memory for temporally storing the arithmetic circuit or the digital value to calculate a position of the pen (magnet) is needed, the circuit may increase in size, and power consumption may increase.

Next, FIGS. 3 and 4 are views illustrating constitutions of the position detection apparatus according to an embodiment. FIG. 3 illustrates a state in which the pen 20 including a magnet 22 is touched to the position detection apparatus. Referring to a structure of the pen 20 of FIG. 3, the pen 20 includes a body part 23 and a head part 21 contacting the detection area 30. At least one portion of the heat part 21 contacting the detection area 30 may be formed of a material having conductivity to detect a touch position through the electrostatic method. Also, the magnet 22 for detecting a position of the pen by the hall element of the position detection apparatus, i.e., through the magnetostatic field method is disposed within the pen 20.

As described above, an additional circuit or power supply units are not provided the pen 20 according to the present embodiment. The position of the magnet 22 may be detected by the hall elements (that will be described later in detail) of the touch panel. Here, the detection of the position of the magnet 22 may use a difference between output voltages of the hall elements according to distances between the magnet 22 and the hall elements. However, because it is unnecessary to operate all of the hall elements to detect the position of the pen from the touch positions, the hall sensors adjacent to a touch position at which possibility of the pen is highest among at least one or more touch positions detected through the electrostatic method may selectively operate.

Also, a pole or position (height) of the magnet 22 may be changed by user's selection. In this instance, because an output voltage of the hall sensor may also be changed, the user may use the changed output voltage as the other input command.

For example, when a button is disposed on an outer surface of the pen 22, and then the user pushes the button, the pole or height of the magnet 22 can be changed. Thus, the position detection apparatus can detect the position of the pen 22 as well as an action of a user for manipulating the pen 22. For example, various additional functions in which an icon is selected by pushing the button of the pen in any application program, or a menu of corresponding application program is displayed may be performed together. The above-described functions will be described in more detail with reference to the accompanying drawings.

Referring to FIG. 4, the position detection apparatus according to an embodiment includes an electrostatic type position detection unit 200 for recognizing touch of a user's finger or pen, a display panel 310 displaying an image, a magnetostatic field type position detection unit 500 for detecting a position of a magnet through a magnetostatic field method, and a control unit 400 for controlling an operation of application program by using position detection information transmitted from the electrostatic type position detection unit 200 and the magnetostatic field type position detection unit 500 or controlling an image displayed on the display panel 310.

The electrostatic type position detection unit 200 may include a touch panel. Also, a protection cover 100 for protecting the panel against the user or the pen may be further disposed on the electrostatic type position detection unit 200.

In detail, the electrostatic type position detection unit 200 may include a generally well-known touch panel. Also, the electrostatic type position detection unit 200 may include an electrostatic sensor part 210 and an electrostatic signal processing part 220. The electrostatic sensor part 210 includes a sensor having a grid or matrix structure in which an indium tin oxide (ITO) layer and a plurality of transparent electrodes are disposed in a first direction and a second direction crossing the first direction. The electrostatic sensor part 210 may detect a position of the finger or the pen. Also, the electrostatic signal processing part 220 may process an electrical signal acquired by the electrostatic sensor part 210.

The present embodiment discloses the detection of the magnet position (the pen position) by using a magnetostatic field sensor part and the detection of the touch position through the electrostatic method. Alternatively, the position of the finger or pen may be detected through other methods in addition to the electrostatic method. For example, various well-known methods such as a resistive overlay method, an optical method, an ultrasonic method, and the like may be replaced with the electrostatic type position detection unit 200.

The display panel 310 is disposed under the electrostatic sensor part 210. The display panel 310 may include various display devices such as an LCD and an OLED. Also, a driving circuit 320 for transmitting a video signal into the display panel 310 may be provided. The driving circuit may perform display of an image and a screen operation by touch according to the control of the control unit 400.

Also, the position detection apparatus according to an embodiment may further include a magnetostatic field position detection unit 500 for detecting a position of the pen including the magnet. The magnetostatic field position detection unit 500 may include a magnetostatic field sensor part 510 including the hall elements and a plurality of signal lines or voltage supply lines and a magnetostatic field signal processing part 520 for operating the magnetostatic field sensor part 510.

The magnetostatic field sensor part 510 may detect a position coordinate of the magnet within the pen 20. The control unit 400 may determines an accurate touch position of the pen from information with respect to the position coordinate transferred from the electrostatic type position detection unit 200 and the magnetostatic field position detection unit 500. For example, when one finger and pen touch the detection area 30 at the same time, touch positions of the finger and pen are sensed through the multi touch from the electrostatic type position detection unit 200 to determine a position of the pen among the touch positions by the magnetostatic field position detection unit 500.

Detailed descriptions with respect to the above-described process will be described with reference to a flowchart with respect to an operation of the control unit. The magnetostatic field sensor part 510 constituting the magnetostatic field position detection unit 500 will be described with reference to FIG. 5.

FIG. 5 is a schematic view of the hall element used in the position detection apparatus according to an embodiment. In the present embodiment, the hall element may be used to detect a position of the pen including the magnet. However, a large number of hall elements may not be used so as to accurately detect the position of the pen. As described above, when a display device having a size of about 4 inches to about 6 inches, when at least five or six hall sensors are provided, the position of the pen may be accurately detected. However, the number of hall sensors may be changed according to a set distance between the pen and the palm. For example, various numbers of hall sensors may be provided in the present embodiment.

Referring to FIG. 5, a hall element 512 includes first and second input terminals 513a and 513b and first and second output terminals 514a and 514b installed in an element body 512a in which a semiconductor thin film such as indium antimonide (InSb) is inserted. The first and second input terminals 513a and 513b and the first and second output terminals 514a and 514b are electrically connected to the semiconductor thin film at positions opposite to each other, respectively.

When a voltage V is applied to the first and second input terminals 513a and 513b, and also a magnetic field is applied to first and second input terminals 513a and 513b in a direction passing from a surface of the semiconductor thin film toward a back surface of the semiconductor thin film, the hall element 512 may generate a potential difference VHM due to magnetic flux density between the first and second output terminals 514a and 514b by a hall effect. The potential difference VHM generated between first and second output terminals 514a and 514b by the hall effect may be referred to as a hall output voltage.

Next FIG. 6 is a view illustrating the magnetostatic field signal processing part of the position detection apparatus according to an embodiment. FIG. 6 illustrates the magnetostatic field sensor part including hall elements and a circuit for sensing a voltage applied to the hall elements that are the magnetostatic field sensor part or an output voltage as illustrated in FIG. 5. The magnetostatic field sensor part 510 includes an insulation substrate 511 and hall elements 512 disposed in a matrix form having at least one row and at least one column on the insulation substrate 511. For convenience of description, the hall elements may be disposed in a 3×3 matrix form. Also, a voltage supply line for transferring a voltage to the hall elements having the same row and a signal output line disposed in a longitudinal direction of the hall elements to transfer a voltage output from the hall elements into a voltage detection circuit 521 are disposed on the insulation substrate 511.

The hall elements disposed in the same row are connected to the same voltage supply line, and the hall elements disposed in the same column are connected to the same signal output line. Also, the magnetostatic field signal processing part 520 includes a voltage supply circuit 522 for applying a voltage to the hall elements and a voltage detection circuit 521 for detecting a voltage output from the hall elements. The voltage supply circuit 522 may include a constant voltage circuit generating a driving voltage applied to each of the hall elements and a switching circuit for successively supplying the driving voltage generated in the row of each of the hall elements by using the voltage supply line at timings different from each other.

The voltage detection circuit 521 may include a voltage sensor for sensing a voltage transferred to the signal output line at timings different from each other in each row. Here, the AD converter and arithmetic circuit for calculating positions of the hall sensors and the magnet may be unnecessary. The control unit 400 may control an operation of the voltage supply circuit 522 and detect a position of the pen including the magnet from a signal output from the voltage detection circuit 521.

A position detection method by using the position detection apparatus according to an embodiment including the above-described components will be described. FIG. 7 is a flowchart illustrating a position detection method according to a first embodiment.

When a user' finger or pen touches a touch panel, the touch position is sensed by an electrostatic type position detection unit 200 (S101). That is, a signal is successively applied to capacitive pixels disposed in a matrix form in the touch panel to detect whether touch occurs or not into an electrical signal.

Also, a touch position is calculated based on a difference between the electrical signals of the pixels (e.g., between a driving electrode and a sensing electrode) in the touch panel (S102). The operations S101 and S102 are separately performed to easily express a sequence. However, the above-described two processes may be performed at a high speed or almost simultaneously. The electrostatic type position detection may be performed through the well-known methods. However, at least one portion of an outer surface of the pen according to an embodiment may be formed of a material in which touch input can be recognized by the electrostatic method. In addition, the pen includes a magnet. Then, the touch position detected by the electrostatic method is stored in a memory such as a memory device (S105). For example, if the pen and the palm touch the touch panel at the same time, pixels within an area contacting the palm may be determined that a contact object exists to calculate the touch position. If the palm contacts a plurality of pixels, outer coordinates of a contact area may be calculated. In this instance, if it is determined that the pixels are touched over a predetermined area, a control unit may determine that an object having a large area such as the user's palm is touched. The above-described calculated touch position is stored in the memory device.

In the position detection method according to the first embodiment, the number of touch position may be counted by the control unit, or a counter may be further provided to count the number of touch position. Here, the counter counts the number of detected touch position (S104). The counting of the number of touch position may be reset for each cycle to return to a zero state whenever the detection (scanning) with respect to the touch position on an entire area of the display panel is finished.

Then, the control unit determines whether an executing application program permits only a single touch (S106). If an executing application program permits a multi touch, an operation of a magnetostatic field position detection unit 500 is maintained in a stop state, and the electrostatic type position detection unit 200 continuously performs the position detection.

However, if an executing application program permits only the single touch as a user's command, to normally execute the application program, it is determined what touch of the finger, palm, and pen is used as the user' input.

In detail, if an executing application program permits only any one input (touch) of the user's finger and the pen, it is determined whether the counted number of touch position is greater than one (S107). That is, if one of the user's finger and the pen is touched on the touch panel, because the one touch is easily used as the user's input in an executing application program, the operation of the magnetostatic field position detection unit 500 is maintained in the stop state, and the electrostatic type position detection unit 200 continuously performs the position detection.

However, if the counted number is greater than one, i.e., the multi touch input is performed in the application program as the user's input for the single touch, the operation of the magnetostatic field position detection unit 500 may start to perform an operation for detecting a position of the magnet provided within the pen 20. As described above, hall elements may operate to determine the position of the magnet provided within the pen. When the detection of the magnet position is performed by a magnetostatic field sensor part 510 (S109), a coordinate of the corresponding magnet (pen) is calculated (S110).

On the other hand, if the magnet position is not detected in the process of detecting the magnet position by the operation of the magnetostatic field position detection unit 500, it may be determined that the user's two fingers are touched, or the palm and finger are touched. When this occurs, because all multi touch positions in the application program for only the single touch input are not used, the control unit outputs an alarm message for informing that a condition is not satisfied (S111). The alarm message may include sound, vibration, or image according to the application program.

The position of the pen detected by the magnetostatic field position detection unit 500 may be a first position. Here, to accurately detect the first position, one of the touch coordinates detected through the electrostatic method may be corrected as a position of the pen to define a second position. Further, the second position of the pen may be referred to as a corrected touch coordinate.

The process of detecting the position of the magnet (pen) by the magnetostatic field position detection unit 500 in the operation S110 will be described in detail. According to embodiments, it may not be needed to densely dispose the hall elements to accurately detect the pen position. If an approximate touch area of the magnet can be determined, an accurate touch position of the pen may be detected from the touch coordinates previously detected by the electrostatic type position detection unit 200.

For example, as shown in FIG. 2, if the user's palm and the pen are touched on the touch panel at the same time, the hall elements may be disposed at a distance less than that A between a general pen and the palm. After the magnet position is detected by the hall elements, a process for selecting a touch position of a recognition object among the touch coordinates stored in the operation S105 is performed (S112). That is, to accurately correct the position of the magnet (pen) detected by the magnetostatic field method, one of the touch positions detected by the electrostatic method may be an accurate position of the magnet (pen), i.e., the corrected position.

In detail, because the touch position of the pen is stored together with the touch position of the palm by the electrostatic type position detection unit 200, the position detection of the pen (magnet) by the magnetostatic field position detection unit 500 may be performed within a range having a radius less than the distance A. When the position of the pen (magnet) is approximately detected by the magnetostatic field position detection unit 500, one of the accurate touch coordinates detected by the electrostatic type position detection unit 200 may be the position of the pen (magnet).

Due to the above-described process, the position detection apparatus may operate the magnetostatic field position detection unit 500 that selectively uses the hall elements as necessary. Also, because it is unnecessary to densely dispose the hall elements to detect the position of the pen including the magnet, manufacturing costs may be reduced. Also, as necessary, the magnetostatic field position detection unit 500 may be selectively operated to reduce power consumption. Also, because only the magnet is provided in the pen, manufacturing price of the pen may be reduced. In addition, it may be unnecessary to apply a power to the pen.

In another embodiment, if a button for changing a position of the magnet is provided to the pen, the user may manipulate the button to change the position of the magnet. In this instance, the density of the magnetostatic field detected by the magnetostatic field position detection unit 500 may be significantly changed.

Through the above-described configuration, a command such as a right or left click of a mouse may be performed together in addition to the touch using the pen by the user. That is, if the magnet is provided within the pen, and thus, the user manipulates the button disposed on the pen to vertically move the magnet or switches poles (an N pole and an S pole) of the magnet, because a change of the magnetostatic field is detected together by the hall elements of the magnetostatic field position detection unit, other user's input may be enabled. The configuration of the pen will be described in detail with reference to FIGS. 12 to 20.

FIG. 8 is a flowchart illustrating a position detection method according to a second embodiment. When a user's finger or pen touches a touch panel, the touch position is sensed by an electrostatic type position detection unit 200 (S201). That is, a signal is successively applied to capacitive pixels disposed in a matrix form in the touch panel to detect whether touch occurs or not into an electrical signal.

Also, a touch position is calculated on the basis of a difference between the electrical signals of the pixels (e.g., between a driving electrode and a sensing electrode) in the touch panel (S202). The operations S201 and S202 are separately performed to easily express a sequence. However, the above-described two processes may be performed at a high speed or almost simultaneously. The electrostatic type position detection may be performed through the well-known methods. However, at least one portion of an outer surface of the pen according to an embodiment may be formed of a material in which touch input can be recognized by the electrostatic method. In addition, the pen includes a magnet.

Then, the touch position detected by the electrostatic method is stored in a memory such as a memory device (S211). For example, if a palm contacts the touch panel, outer coordinates of a contact area over a plurality of pixels may be calculated. In this instance, if it is determined that the pixels are touched over a predetermined area, a control unit may determine that an object having a large area such as the user's palm is touched. The above-described calculated touch position is stored in the memory device.

In the present embodiment, the number of touch position may be countered by the control unit, or a counter may be further provided to counter the number of touch position. Here, the counter counters the number of detected touch position (S203). The counting of the number of touch position may be reset for each cycle to return to a zero state whenever the detection (scanning) with respect to the touch position on an entire area of the display panel is finished.

Then, the control unit determines whether an executing application program permits only a single touch (S204). If an executing application program permits a multi touch, an operation of a magnetostatic field position detection unit 500 is maintained in a stop state, and the electrostatic type position detection unit 200 continuously performs the position detection (S212).

However, if an executing application program permits only a single touch as a user's command, it is determined whether the number of touch position detected by the electrostatic type position detection unit 200 is the single touch or the multi touch (S205). That is, it is determined whether the touch number counted by the counter is greater than one. For example, according to the application program, only a stylus pen may be used as the user's input. In this instance, a system may be set so that only the single touch is permitted from the beginning of the corresponding application program. According to the present embodiment, an operation of the magnetostatic field position detection unit 500 for detecting a position of the magnet provided within the pen is not operated yet.

In the determined result of the operation S205, even though the system is set so that an executing application program permits only the single touch, if the number of touch position detected by the electrostatic method is two, it is determined whether a distance between the touch positions detected by the electrostatic method is greater than a reference value (e.g., about 3 cm) (S206).

For example, if the other touch position exists within a radius of about 3 cm with respect to a center of each touch position among the plurality of touch positions detected by the electrostatic method, it may be determined that the two touches are not performed by the pen. As described above, because it is assumed that a minimum distance between the pen and the palm is about 3 cm, if a distance between the touched positions is within about 3 cm, possibility in which the positions occur by the user's palm or finger may be very high. Thus, in this instance, it is not assumed that the positions occur by the pen.

Thus, only when the other object does not exist within a radius of about 3 cm with respect to the center of the touch position among the touch positions detected by the electrostatic method, this may be considered as the touch position of the pen.

Then, the touch positions existing outside a radius of about 3 cm among the touch positions detected by the electrostatic method may be determined as a candidate of the pen touch position. Then, a process for determining a position between the touch positions determined as the candidate and the installed hall sensor is performed. That is, the hall element nearest to the touch position candidate of the pen may be selected to make a mapping table with respect to therebetween. If the touch position candidate is disposed at a center of four hall sensors, one of the four hall sensors may be used.

To make the mapping table, an operation of the magnetostatic field position detection unit 500 starts. Then, the control unit confirms a voltage output from the selected hall element (S208). Also, even though a plurality of selected hall elements exist in the present embodiment, the position of the magnet (pen) is not calculated from the output voltages of the hall elements, but a large and small relationship between the output voltages of the hall elements is compared.

That is, if the number of touch position of the pen candidate is one, an output voltage of the nearest hall element may be a maximum output. Thus, the output voltage may become to Vo_max. However, if the number of touch position of the pen candidate is two or more, a process of comparing output voltages of the two hall elements is performed. Here, a relatively high output voltage may be a temporary Vo_max, and then the temporary Vo_max is compared to an output voltage of the hall element which is not compared yet to the hall element having the relatively high output voltage. Then, according to the comparison result, the relatively high output voltage may be set to the Vo_max, and also, this process may be continuously performed until the comparison object does not exist (S209).

When the output voltages are compared and determined, all of the output voltages of the installed hall elements may be successively compared. However, in this instance, a large amount of time and power may be consumed. Thus, the hall elements nearest to the touch position of the pen candidate may be selectively operated to confirm output voltages thereof, thereby comparing the large and small relationship between the output voltages.

In the process of comparing the output voltages of the hall elements, after the Vo_max is determined, it may be determined whether the Vo_max is greater than a preset threshold value. If the Vo_max is less than the threshold value even though the Vo_max is determined, it may be determined that the pen does not contact the touch panel.

If the Vo_max is greater than the preset threshold value, it may be recognized that the pen is touched around the hall element outputting the corresponding Vo_max. In this instance, because a distance with the touch position is not accurately calculated by using the hall element, the touch position confirmed by the electrostatic method may correspond thereto. That is, if a distance between the hall elements ranges about 3 cm to about 4.5 cm, the control unit may determine that the touch position nearest to the hall element outputting the highest voltage corresponds to the pen position (S209).

According to the above-described process, the pen position may be accurately determined by using only a small number of hall elements. Also, the hall elements are selectively operated as necessary, the power consumption due to the operations of the hall elements may not be problem. Then, when the hall elements are operated, because an executing application program permits only the single touch, only the detected touch position of the pen may be used as a user's command in the corresponding application program (S210).

FIGS. 9 to 11 are views illustrating an arrangement of hole devices constituting a magnetostatic field position detection unit. Referring to FIG. 10, when a touch panel having a size of about 5 inches, i.e., about 10 cm×7 cm which is used for a smart phone or a small tablet PC is provided, four hall elements may be provided at a distance of about 3 cm in a transverse direction. Also, three hall elements may be provided at a distance of about 3 cm in a longitudinal direction. Thus, total twelve hall elements may be provided. In this instance, if the pen is used in a state where the palm is touched on the detection area, it may be assumed that a distance between the palm and the pen is above at least 3 cm. If it is assumed that a distance between the palm and the pen is about at least 2 cm, more hall elements may be provided when compared to a case illustrated in FIG. 10. Thus, a design with respect to the arrangement of the hall elements may be variously changed.

Also, in the arrangement of the hall elements illustrated in FIG. 9, if less hall elements are provided, as described above, the position candidates of the pen may be selected from the touch positions detected by the electrostatic method. Then, the hall elements nearest to the selected touch position may be selectively operated to compare a large and small relationship between the output voltages. In this process, the hall element having the highest output voltage may be confirmed. Thus, the touch position nearest to the corresponding hall element may be determined as the pen position.

However, if the touch position is detected by the electrostatic method, the touch position selected as the pen position candidates is provided in plurality, and the corresponding touch positions have the same distance as the hall elements, it may be difficult to accurately determine the pen position by operating only the hall element having a minimum distance (a first distance).

In this instance, a process of comparing a large and small relationship between output voltages of the hall elements disposed at a next close distance (a second distance) to each other may be performed. If it is difficult to determine the hall element having the highest output voltage through above-described process, a hall element disposed at a next close distance (a third distance) may be operated.

Also, when the touch panel has a size of about 5 inches, as shown in FIG. 11, nine hall elements may be provided. This may be mainly described with respect to a first hall element H1. If the pen is disposed within a first region R1 around the first hall element H1, the first hall element may have the highest output.

Also, when the above-described condition is satisfied, and a second hall element H2 corresponds to a second close position, the pen may be disposed within a second region R2 having an isosceles triangular shape toward the second hall element within the first region R1. Also, when the two conditions are satisfied, and a third hall element H3 corresponds to a third close position, the pen may be disposed within a third region R3 having a right triangular shape toward the third hall element within the second region R2. If a distance between the hall elements is adjusted so that a hypotenuse of the right triangle in the third region R3 has a length of about 3 cm, the pen position may be further accurately detected among the touch positions through the distances between the hall elements.

In the present embodiment, it is unnecessary to perform a process of converting analog output voltages of the hall elements into digital signals by using an AD converter. That is, a small and large relationship between the analog output voltages of the hall elements may be compared to each other by using a simple comparator. Also, in the present embodiment, a sampling capacitor may be built in, and then the analog output voltages of the hall elements may be stored in the sampling capacitor. The sampling capacitor may be used in a switch capacitor circuit. Also, the sampling capacitor may compare a small and large relationship between an analog output voltage of a hall element sampled in a first cycle and an analog output voltage of a hall element sampled in a second cycle.

FIGS. 12 to 14 are views of the pen which is capable of being used in the position detection apparatus according to the first embodiment. As described above, the permanent magnet is disposed within the pen in the present embodiment. Here, the recognition by the hall sensor may be enabled by only providing the magnet. Also, if the magnet disposed within the pen is selectively moved (in height or position) by the user, the voltage output from the hall sensor may be changed. Thus, this may be used as the other user's input command in addition to the user's touch input.

Referring to FIG. 12, the pen according to the first embodiment includes a head part 621, a body part 623, and an elevation button 624. At least one portion of the head part 621 may be formed of a conductive material. When a portion of the head part 621 is touched on the detection area of the position detection apparatus, the position detection apparatus detects a touch position of the pen by using the electrostatic method.

However, if the touch is performed on a plurality of areas, the magnet may be provided to accurately determine whether the touch position occurs by the pen or the finger. Here, the magnet may be moved in position by manipulating the elevation button 624 by the user.

FIGS. 13 and 14 are views illustrating an inner structure of the pen according to the first embodiment. Referring to FIGS. 13 and 14, two first and second magnets 622a and 622b are disposed inside the head part 621. Although the first magnet 622a is changed in position in the present embodiment, only one magnet may be provided, and thus, the magnet may be changed in position by manipulating the elevation button.

The structure in which the magnet is changed in position by manipulating the elevation button 624 will be described. The first magnet 622a of the magnets disposed inside the head part 621 has one end connected to a magnet connection member 625. The magnet connection member 625 is connected to a spring connection member 626 fixed to a spring 640. Also, the spring connection member 626 is connected to a rod connection member 628 disposed above the spring connection member 626.

The spring 640 has one end fixed to the spring connection member 626 and the other end fixed to a predetermined portion of the body part 623. Also, the spring may be provided in plurality. For example, first and second springs 641 may be disposed on both sides with respect to the magnet connection member 625.

Thus, when the rod connection member 628 ascends in position, the spring connection member 626 and the magnet connection member 625 which are connected to the rod connection member 628 may also ascend in position. Also, if the magnet connection member 625 ascends in position, the first magnet 622a may also ascend in position to change a voltage output from the hall sensor.

A structure in which the rod connection member 628 ascends in position will be described below. A button inside protrusion 624a protruding by a predetermined length is disposed inside the elevation button 624. A hole having a size enough to elevate the button inside protrusion 624a is defined in the body part 623.

Also, a rotation rod 629 connected to the button inside protrusion 624a and the rod connection member 628 is further provided. A rod fixing pin 630 passes through a central region of the rotation rod 629, and the rod fixing pin 630 is connected to an inner surface of the body part 623.

The button inside protrusion 624a and the rotation rod 629 are connected to each other by a first moving pin 631. The first moving pin 631 is fixed to the button inside protrusion 624a and passes through a first hole 629a defined in the rotation rod 629.

Also, the rod connection member 628 and the rotation rod 629 are connected to each other by a second moving pin 632. The second moving pin 632 is fixed to the rod connection member 628 and passes through a second hole 629b defined in the rotation rod 629.

Through above-described structure, when the elevation button 624 descends by a user, the rotation rod 629 rotates about the rod fixing pin 630. Here, the first moving pin 631 may move in a left direction along the first hole 629a, and the second moving pin 632 may also move in the left direction along the second hole 629b.

Also, due to the movement of the second moving pin 632 and the rotation of the rotation rod 629, the rod connection member 628 ascends. As a result, the magnet connection member 625 and the first magnet 622a may ascend. Here, because the spring 640 is fixed to the spring connection member 626, when the user releases the elevation button 624, the magnet connection member 625 and the magnet may return to their original positions by an elastic force of the spring 640.

If a stylus pen having this structure is used, the user may use the stylus pen as the other input command in application program. That is, the touch of the pen may be a user's first input command, and the position change of the magnet through the manipulation of the elevation button may be the other user's input command.

Another embodiment in which the magnet is changed in position by manipulating the button provided in the pen will be described below. FIG. 15 is a view illustrating an inner structure of a pen according to a second embodiment. A magnet 722 disposed inside a head part 721 of a pen is connected to a magnet connection member 725. The magnet connection member 725 is connected to a spring connection member 726 fixed to a first spring 740. Also, the spring connection member 726 is connected to a first rod connection member 728 disposed above the spring connection member 726.

The first spring 740 is disposed under the spring connection member 726. Also, the first spring 740 has one end fixed to the spring connection member 726 and the other end fixed to a predetermined portion of a body part 723. Also, the spring fixed to the spring connection member 726 may be provided in plurality. As shown in FIG. 15, the springs may be disposed on both sides with respect to a center of the magnet connection member 725.

Thus, when the first rod connection member 728 ascends in position, the spring connection member 726 and the magnet connection member 725 which are connected to the first rod connection member 728 may also ascend in position. Also, if the magnet connection member 725 ascends in position, the magnet 722 may also ascend in position to change a voltage output from a hall sensor.

A structure in which the rod connection member 728 ascends in position will be described. A button inside protrusion 724a protruding by a predetermined length is disposed inside a push button 724 pressed by a user. A hole having a size enough to allow the button inside protrusion 724a to pass therethrough is defined in the body part 723.

Also, the button inside protrusion 724a and a rotation rod 729 are connected to each other by a second rod connection member 733. One end of the second rod connection member 733 is fixed to the button inside protrusion 724a by a protrusion fixing pin 734. Thus, the second rod connection member 733 may rotate at a predetermined angle about the protrusion fixing pin 734. The other end of the second rod connection member 733 is connected to the rotation rod 729 by a first moving pin 731. The first moving pin 731 may move along a first hole 729a defined in the rotation rod 729.

The first rod connection member 728 is connected to the rotation rod 729 by a second moving pin 732. The second moving pin 732 may move along a second hole 729b defined in the rotation rod 729.

Thus, when a user pushes the push button 724, the second rod connection member 733 rotates in a counterclockwise direction about the protrusion fixing pin 734. Here, the first moving pin 731 connected to the second rod connection member 733 may move in a left direction, and thus the rotation rod 729 rotates in the counterclockwise direction. Also, because the rotation rod 729 rotates in the counterclockwise direction, the second moving pin 632 moves in the left direction along the second hole 729b. Because the second moving pin 732 moves, the first rod connection member 728 ascends by a predetermined height. Also, due to the ascending of the first rod connection member 728, the spring connection member 726 and the magnet connection member 725 may ascend by a predetermined height. As a result, the magnet 722 may also ascend.

A second spring 750 may be further provided between the second rod connection member 733 and an inner surface of the body part 723 so that the magnet 722 may easily return to its original position when the user releases a force applied to the push button 724. Due to the pen structure as described above, the user may selectively change a position of the magnet to change an output voltage of a hall sensor. As a result, this may be used as the other user's input command.

FIG. 16 is a view illustrating an inner structure of a pen according to a third embodiment. A magnet 822 disposed inside a head part 821 of a pen is connected to a magnet connection member 825. The magnet connection member 825 is connected to a spring connection member 826 fixed to a first spring 840. Also, the spring connection member 826 is connected to a protrusion connection member 828 disposed above the spring connection member 826.

The first spring 840 is disposed under the spring connection member 826. Also, the first spring 840 has one end fixed to the spring connection member 826 and the other end fixed to a predetermined portion of a body part 823. Also, the spring fixed to the spring connection member 826 may be provided in plurality. As shown in FIG. 16, the springs may be disposed on both sides with respect to a center of the magnet connection member 825.

In this structure, when the protrusion connection member 828 ascends in position, the spring connection member 826 and the magnet connection member 825 which are connected to the protrusion connection member 828 may also ascend in position. Also, if the magnet connection member 825 ascends in position, the magnet 822 may also ascend in position to change a voltage output from a hall sensor.

A structure in which the protrusion connection member 828 ascends in position will be described. A first protrusion 841 protruding by a predetermined length and a second protrusion 842 extending from a predetermined portion of the first protrusion 841 are disposed inside the push button 824 pressed by the user. Also, a third hole 853 is defined in the second protrusion 842 so that a third moving pin 863 moves. The third moving pin 863 is connected to the protrusion connection member 828.

Also, at least one hole is defined in the first protrusion 841, and a moving pin moving in the hole may be provided in the first protrusion 841. For example, a first hole 851 and a second hole 852 are defined in the first protrusion 841. A first moving pin 861 moving along the first hole 851 is fixed to an inner surface of the body part 823. Also, a second moving pin 862 moving along the second hole 852 is fixed to the inner surface of the body part 823.

Also, a second spring 850 is connected to an end of the first protrusion 841. The second spring 850 has the other end fixed to the inner surface of the body part 823. Also, the second protrusion 842 extends from a portion between the first and second holes 851 and 852 of the first protrusion 841. The second protrusion 842 has a curved shape having a predetermined curvature radius.

According to the above-described structure, when the user presses the push button 824, the first and second moving pins 861 and 862 move in a left direction along the holes. Here, the third moving pin 863 may also move along a hole defined in the second protrusion 842. The reason in which each of the second protrusion 842 and the third hole 853 has a predetermined curvature radius is for more easily moving the third moving pin 863 in a left upward direction.

Because the third moving pin 863 moves in the left upward direction, the magnet connection member 825 and the magnet 822 may move upward. When the user releases the force applied to the push button 824, the magnet may easily return to its original position by an elastic force of the second spring 850. Due to the pen structure as described above, the user may selectively change a position of the magnet to change an output voltage of a hall sensor. As a result, this may be used as the other user's input command.

The pen according to the first to third embodiments has the structure in which the height of the magnet is selectively changed by the user. On the other hand, a pen according to a fourth embodiment has a structure in which N and S poles of a magnet may be switched to change an output voltage of a hall sensor.

FIGS. 17 to 20 are views of a pen according to a fourth embodiment. First, a structure of a pen according to a fourth embodiment will be described with reference to FIG. 17. The pen includes a body part 923 defining an outer appearance thereof and a head part 921 connected to the body part 923. Here, at least one portion of the head part 921 may be formed of a conductive material.

A portion of an outer surface of the head part 921 is formed of a conductive material. Thus, when the heat part 921 is touched on a detection area of a position detection apparatus, the position detection apparatus detects a touch position of the pen by using an electrostatic method.

Also, when the user presses the head part 921, a portion of the head part 921 may move into the body part 923. Thus, the head part 921 ascends to change magnets 922a and 922b in position. That is, the second magnet 922b rotates so that a pole of the second magnet 922b facing a hall sensor has an opposite polarity. Thus, because the second magnet 922b rotates, the first magnet 922a ascends upward by a repulsive force of the second magnet 922b.

When the pen is pressed downward, the movement of the heat part 921 and the movements of the first and second magnets 922a and 922b will be described in detail. First, the body part 923 defining the outer appearance of the pen has an accommodation space therein. An inner housing 924 is disposed in the accommodation space. Also, the body part 923 and the inner housing 924 are spaced a predetermined distance from each other. Also, an end of the head part 921 may move into the spaced space.

Two magnets may be disposed within the head part 921 and the body part 923. The first magnet 922a is disposed within the inner housing 924. Also, the second magnet 922b is disposed under the first magnet 922a. The head part 921 and the second magnet 922b are connected to each other by a magnet rotation rod 925.

Also, the magnet rotation rod 925 is connected to both ends of the head part 921 and passes through the second magnet 922b. That is, both sides of the magnet rotation rod 925 passing through the second magnet 922b are connected to an inner circumference surface of the head part 921. An end 925a of the magnet rotation rod 925 is rotatably connected to the inner circumference surface of the head part 921 so that the magnet rotation rod 925 is rotatable.

Particularly, the magnet rotation rod 925 has a shape of which a portion is bent toward the inner housing 924. A ring hook part 925b having a bent shape is disposed between the second magnet 922b and the end 925a. Also, a fixing ring 926 is coupled to the ring hook part 925b of the magnet rotation rod 925. A portion of the magnet rotation rod is connected to the inner housing 925 by the fixing ring 926.

According to the above-described structure, when the head part 921 of the pen is pressed downward in the drawing, both ends of the head part 921 ascends in a space between the inner housing 924 and the body part 923. Also, when the head part 921 ascends, the magnet rotation rod 925 connected to the head part 921 rotates about the fixing ring 926. Thus, because the magnet rotation rod 925 rotates, the second magnet 922b rotates. That is, as shown in FIG. 18, when the magnet rotation rod 925 rotates, the second magnet 922b may also rotate. Thus, as shown in FIG. 20, the magnet may rotate. Also, a hook piece 940 for assisting the rotation may be disposed on an upper portion of the second magnet 922b so that, when the second magnet 922b rotates, the second magnet 922b does not interfere with the first magnet 922a.

Referring to FIG. 19, when the heat part 921 is pressed to apply a rotation force to the magnet rotation rod 925, the second magnet 922b connected to the magnet rotation rod 925 may gradually rotate. Thus, N and S poles of the second magnet 922b may be disposed opposite to each other. Thus, an attractive between the first and second magnets may be converted into a repulsive force therebetween. Thus, the first magnet 922a may move upward within the inner housing 924 by the repulsive force.

Due to the movement of the magnet, whether the magnet rotates may be sensed by using only a comparator even thought a sampling capacitor is not provided. When the polarities of the magnets are changed to invert a direction of a magnetic line, the output voltage may move symmetrically with respect to a virtual ground.

For example, when a magnetic field is generated in a magnet having a ground voltage of about 1.5 V to apply a voltage of about 3 V as an operation potential of the hall element, if an output voltage of the hall element has a voltage of about 1.6 V, an output voltage may have an inverted voltage of about 1.4 V when the magnet is reversed in polarity. Thus, when the virtual ground is applied as one input of the comparator, an output of the comparator may be reversed if the magnet rotates. Whether the button of the pen is input may be confirmed through above-described method.

According to the position detection apparatus and method, because the position of the stylus is detected through the magnetostatic field method, it may be unnecessary to generate parallel alternating magnetic fields. Thus, a power required for the alternating magnetic fields may not be consumed. In the position detection apparatus according to the embodiments, because the position detection of the pen using the hall element is performed when preset conditions are satisfied, the power consumption due to the use of the pen may be reduced, and also, the noise occurring when the position is detected through the electrostatic method may be reduced. Also, in the position detection apparatus according to the embodiments, because fewer number of hall sensors are provided, the manufacturing costs due to the number of hall sensor may be reduced.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile terminal comprising:
a touchscreen configured to detect a touch of a finger or pen;
a sensor configured to detect a position of a magnet disposed within the pen; and
when the touchscreen is in a multiple touch mode, a controller configured to receive input from the touchscreen, and
when the touchscreen is in a single touch mode and a touch of the finger and pen are detected, the controller configured receive input from the sensor.

2. The mobile terminal according to claim 1, wherein, when the touchscreen detects the touch of the finger and pen, and an executing application program permits only a single touch, the controller is configured to start position detection by the sensor.

3. The mobile terminal according to claim 2, wherein, when the position of the magnet is not detected by the sensor, the controller is configured to control the mobile terminal to output one alarm message of a sound, a vibration, or images.

4. The mobile terminal according to claim 2, wherein the controller is configured to determine a touch position coordinate within a range that is nearest to the position of the magnet detected by the sensor as a position of the pen.

5. The mobile terminal according to claim 1 further comprising:
a sensor processor including a voltage supply circuit configured to apply a voltage to a hall element and a voltage detector configured to detect a voltage output from the hall element, and
wherein a distance between the hall element and another hall element is less than a preset distance A that corresponds to a distance between a user's palm and the pen when a user grasps the pen.

6. The mobile terminal according to claim 1, wherein when an application program executing through the display panel permits only a single touch input as a user's input command, and at least two touch inputs are recognized through the touchscreen, the controller is configured to start an operation of the sensor.

7. The mobile terminal according to claim 6, wherein, before the sensor starts, the controller is configured to select a touch position in which a distance between two touch positions is greater than a preset distance from the at least two recognized touch positions and selects a hall element adjacent to the selected touch position.

8. The mobile terminal according to claim 7, wherein the controller is configured to selectively operate the hall element adjacent to the selected touch position.

9. The mobile terminal according to claim 8, wherein, when more than one hall element is provided adjacent to the selected touch position, the controller is configured to compare voltages outputted from the hall elements to each other to detect a hall element outputting a highest voltage.

10. The mobile terminal according to claim 9, wherein the controller is configured to determine a touch position nearest to the hall element outputting the highest voltage as a pen position.

11. The mobile terminal according to claim 10, wherein the controller is configured to use the determined pen position as a user's command of the application program.

12. A display apparatus comprising:
a touchscreen configured to detect a touch of a finger or pen on a display panel;
a sensor having at least one hall element and configured to detect a position of a magnet disposed within the pen; and
a controller configured to:
determine a touch position of the finger or pen by using position detection information transmitted from the touchscreen and the sensor,
when the touchscreen is in a multiple touch mode, receive input from the touchscreen, and
when the touchscreen is in a single touch mode and a touch of the finger and pen are detected, receive input from the sensor.

13. The display apparatus according to claim 12, wherein the controller is further configured to start position detection by the sensor when the multi touch input is detected by the touchscreen and an executing application program permits only a single touch input.

14. The display apparatus according to claim 12, wherein the controller is further configured to output an alarm including at least one of a sound, a vibration, or at least one image when the position of the magnet is not detected by the sensor.

15. The display apparatus according to claim 12, wherein the controller is further configured to determine a touch position coordinate within a range that is nearest to the position of the magnet detected by the sensor as a position of the pen.

16. The display apparatus according to claim 12 further comprising:
a sensor processor including a voltage supply circuit configured to apply a voltage to the hall element and a voltage detector configured to detect a voltage output from the hall element, and
wherein a distance between the hall element and another hall element is less than a preset distance A that corresponds to a distance between a user's palm and the pen when the user grasps the pen.

17. The display apparatus according to claim 12, wherein when an application program executing through the touchscreen permits only a single touch input as a user's input command and at least two touch inputs are detected by the touchscreen, the controller is configured to start an operation of the sensor.

18. The position detection apparatus according to claim 17, wherein, before the operation of the sensor starts, the controller is configured to select a touch position in which a distance between two touch positions is greater than a preset distance from the at least two recognized touch positions and to select a hall element adjacent to the selected touch position, and
wherein the controller is configured to selectively operate the hall element adjacent to the selected touch position.

19. The position detection apparatus according to claim 18, wherein, when a plurality of hall elements adjacent to the selected touch position are provided, the controller is configured to compare voltages output from the hall elements to each other to detect a hall element outputting the highest voltage,
wherein the controller is configured to determine a touch position nearest to the hall element outputting a highest voltage as a pen position, and
wherein the controller is configured to use the determined pen position as a user's command of the application program.

20. A position detection method comprising:
detecting a touch coordinate inputted into a touchscreen;
storing the touch coordinate;
counting a number of detected touch positions to determine whether an executing application program permits only a single touch input; and
selectively operating a sensor for detecting a position of a magnet using a magnetic field generated from the magnet when the executing application program permits only the single touch input, the selectively operating of the sensor comprising
detecting the position of the magnet using the magnetic field generated from the magnet, and
providing the touch coordinate detected by the touchscreen as a plurality of coordinates;
determining a touch coordinate disposed within a preset range from the detected first position of the magnet among the stored touch coordinates as a corrected position of the magnet;
when the executing application program permits only the single touch input, selecting a touch position in which a distance between touch positions is greater than a preset distance from the at least two recognized touch positions; and
when the executing application program permits only the single touch, selecting a hall element nearest to the selected touch position,
wherein, when the executing application program permits only the single touch input, a voltage is applied to hall elements of the sensor, and an intensity of the magnetic field generated from the magnet is outputted as an output voltage to detect a first position of the magnet.
